(19) United States
(12) Patent Application Publication
(10) Pub. No.: US 2020/0228023 A1
(43) Pub. Date: Jul. 16, 2020

(54) Capacitive Switching Device

(71) Applicant: Cesar Ladron de Guevara, (US)

(72) Inventor: Cesar Ladron de Guevara, (US)

(21) Appl. No.: 16/246,932

(22) Filed: Jan. 14, 2019

(51) Int. Cl. H02M 5/08

(52) U.S. Cl. CPC H02M 5/08; H01G 4/38

(57) ABSTRACT

Capacitive switching device and method utilizing capacitive methods, switch mechanisms and structure to switch on and off of the transfer of alternating current (AC), pulsed power or signals from input side to an output side. More specifically, the present invention relates to AC or pulse decoupled structure which electrically and electronically provides the means to instantaneously switch on and off the transferring forward of power or signal from input terminal connections to output terminal connections. By controlling electrostatic charges to migrate, or not to migrate from its input electrodes to its output electrodes, power or signal transfer forward is controlled.

### CROSS-REFERENCE TO RELATED APPLICATIONS

This application claims priority under 35 U.S.C. #119(e) of the U.S. provisional patent application Ser. No. 62/709,447 filed Jan. 16, 2018 which is incorporated by reference herein.

### REFERENES CITED

U.S. PATENT DOCUMENTS

| | | |
|---|---|---|
| U.S. Pat. No. 9,438,129 B2 | September 2016 | Ladron de |
| | | Guevara et al. |

### BACKGROUND AND SUMMARY OF THE INVENTION

### 1. Field of the Invention

The present invention relates generally to a capacitive switching device and methods utilizing capacitive methods, switch mechanisms and structure to switch on and off of the transfer of alternating current (AC), pulsed power or signals from an input side to an output side. More specifically, the present invention relates to AC or pulse decoupled structure which electrically and electronically provides the means to instantaneously switch on and off the transferring forward of power or signal from input terminal connections to output terminal connections. By controlling electrostatic charges to migrate, or not to migrate to its output electrodes, power and signal forward controlled.

### 2. Summary of the Invention

A device in accordance with the present invention provides a means for instantaneously switching off and on AC, pulse power or signal flow from its primary side input terminals to its secondary side output terminals. The power supply circuitry, which is connected to the primary side of the device, provides electrostatic charges to the input electrodes. These electrostatic charges on the input electrodes migrate to output electrodes, thus transferring power and voltage to the output side of the device. The switching mechanism utilized by the invention relates to the known functionality of a capacitor. A capacitor transfers electrostatic charges when there exists a potential differential between its input and output electrodes.

The capacitive structure of the present invention permits the controlling of the electrostatic transfer by its unique configuration of the relationship between its input electrodes and output electrodes. With its input electrodes connected to each leg of its power source, and each of its output electrodes connected to each leg of the Load, this configuration provides the means with which a switching circuit containing a switch mechanism is connected and bridged between the invention's common input leg of the power source, and its output Load leg of the connected Load. With said configuration, by having the switch mechanism of the switching circuit in a closed position, the forgoing transfer of power or signal from the invention's input side to output side is terminated because differential potential between output electrodes are eliminated. When the device's switching mechanism is de-activated to sit open configuration, the differential potential of the output electrodes re-occur and power or signal transfer is resumed.

The present invention provides many advantages over forward power switching methods, apparatus technologies and inventions as known by those familiar in the art. These advantages of the present invention include, but are not limited to: (1) providing a means for decoupled power and voltage transfers between two circuitries; (2) providing a means for electrical decoupling between two AC power supply sources feeding a common circuit; (3) providing a means for transferring from the input side to the output side an equivalent voltage value as is referenced as existing on the input side; (4) providing a means for terminating or regaining the forward power transfer by controlling electrostatic transfer between electrodes.

The power and signal transfer technique practiced by the present invention has a unique means of utilization of its components, namely, a plurality of input electrodes with at least one dielectric layer between each pair of adjacent input electrodes, and a plurality of output electrodes with at least one dielectric layer between each pair of adjacent of input and output electrodes in a common structure whereby the input electrodes of each pair are adjacent to each other and disposed within a pair of the exterior output electrodes.

### BRIEF DESCRIPTION OF THE DRAWINGS

For a more complete understanding of the present invention, reference is made to the following detailed description of the invention considered in conjunction with the accompanying drawings, in which:

FIG. 1 is a diagram of a capacitive switching device in accordance with the invention;

FIG. 2 is a diagram of equivalent circuitry of the capacitive switching device shown in FIG. 1;

### DETAILED DESCRIPTION OF THE INVENTION

In the following detailed descriptions, reference is is made to the accompanying figures which form a part thereof, and in which is shown, by way of illustration of the principles of the invention, specific embodiments of ways in which the invention may best be practiced. In the drawings, like numerals describe substantially similar components throughout the various views of the embodiments. These embodiments are described in sufficient detail to enable those skilled in the art to practice the invention. Other embodiments of the principles of this disclosure may be used, and various structural and material changes may be made to the embodiments disclosed herein without departing from the scope and principles of the present invention. It should be noted that the components of the present invention can be assembled from individual off the shelf components, and configured as a part of circuitries as is used by various industries, while still holding true to the intent of the present invention.

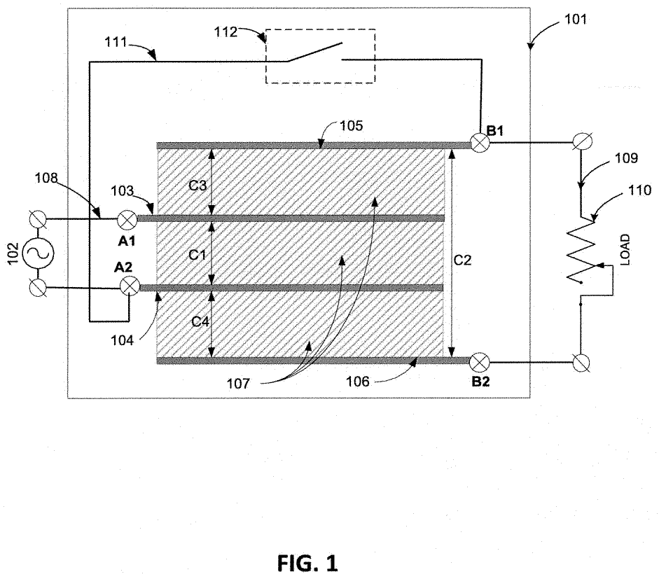

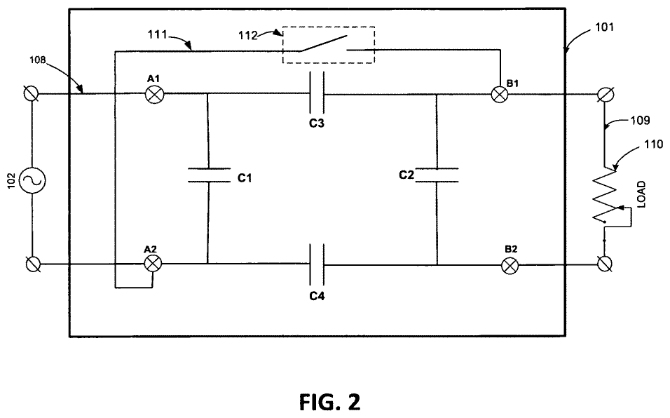

Referring first to FIGS. 1 and 2, in one embodiment of a capacitive switching device 101 for controlling input/output power and signal transfer, an AC-AC power transfer at, for example, 110 to 125 VAC 102 from an input or primary side (V1—the left of the capacitive switching device 101) to an output or secondary side (V2—the right of the capacitive switching device 101) is accomplished while maintaining the same, or substantially the same, range of voltage as is available on the primary side, while capacitive switching device 101 is in a pass through operational mode,

FIG. 1 shows side view of the construction of the capacitive switching device 101 wherein use of switchable circuit 111 and thin film capacitive structure is evident. The capacitive structure includes two input electrodes 103, 104 and two output electrodes 105, 106 with each pair of adjacent electrodes 103, 104, 105, 106 being separated by one or more layers of a dielectric film 107. As shown, a layer of dielectric film 107 is present between input electrodes 103 and 104, another layer of dielectric film 107 is present between input electrode 103 and output electrode 105, and yet another layer of dielectric film 107 is present between input electrode 104 and output electrode 106. The input and output electrodes 103, 105 are decoupled, and the input and output electrodes 104, 106 are decoupled.

Input electrodes 103, 104 are connected to terminals A1, A2, respectively, by lead connectors and the output electrodes 105, 106 are connected to terminals B1, B2, respectively, by lead connectors. The lead connectors for the input electrodes 103, 104 are decoupled while the lead connectors for the output electrodes 105, 106 are also decoupled. External access to the device 101 is enabled from input circuitry, represented generally as 108, connected to terminals A1, A2 and output circuitry, represented generally as 109, connected to terminals B1, B2.

Switchable circuit 111 is linearly connected to input terminal A2 and output terminal B1. The switchable circuit contains a switch mechanism 112 which has a means of creating an open or closed switchable circuit 111 on demand. The switch mechanism 112 function as is generally described herein has a means of causing the switchable circuitry to conduct or not conduct the transference of electrons from one side of the switch mechanism 112 to its other side. The switch mechanism 112 could be any device, as an example, mechanical, electrical, electronic, etc., which performs the functions as required by the present invention 101 to control of transfer of electrons so as to provide the means of the present invention to switch on and off the transfer of power or signal from terminals A1 A2 to B1 B2.

The foregoing description and illustration in FIG. 1 of the cross-sectional view enables one skilled in the art to manufacture the capacitive switching device 101, e.g., providing a housing and suitable electrical connections and isolations and suitable switching device. The capacitive switching device 101, when manufactured, will have the appearance and sizes similar in fashion to existing capacitor designs as are cataloged by capacitor manufacturers and recognized as such by those familiar in the art. The uniqueness of the capacitive switching device 101 is the presence of two decoupled input leads and two decoupled output leads, and a switchable circuit 111 containing a switching device 112, with their positioning on the capacitive switching device 101 being dictated by customer and manufacturing design criteria.

The selection of materials from those available for constructing the components of the device 101 shown in FIG. 1 is varied and easily obtainable by those familiar in the art. An exemplifying, non-limiting preferred embodiment of capacitive switching device 101 utilizes electrode and dielectric materials that provide the equivalent capacitance values being dictated by customer and manufacturing design criteria. All capacitive specifications, circuitry methods and switch mechanisms, as would be utilized in the constructed formats described as in FIG. 1 of the invention, would comply with the claimed switchable performance of the present invention.

Utilizing electrode and dielectric materials that provide the capacitance values which deliver potential differentials at positions C1, C2, C3 and C4, and whereas a switchable circuit is connected to terminals A2 and B1, and whereas the switchable circuit 111 switch mechanism 112 is in open position, the present invention provides the means of transferring power or signal, from capacitive switching device 101 input terminals A1, A2 to its output terminals B1, B2 and deliver such power and/or signal as per its manufactured design specifications. Upon the switchable circuit 111 switch mechanism 112 is positioned in a closed position, the transferring of power and/or signal through the capacitive switching device 101 ceases.

Electrostatic transference of power across electrodes via potential differential is the known technology utilized in capacitor functionality. As is with the current invention, electrostatic charges are transferred from input electrodes 103, 104 to output electrodes 105, 106 via their potential differential. Upon the closing of capacitive switching device 101 switching circuit 111, the capacitive switching device 101 output electrodes 105, 106 obtain the same and equal charges and thereby potential differential of its output electrodes 105, 106 are eliminated and thus terminating the capacitive switching device 101 capability of electrostatic transfer of energy from its input side terminals A1 A2 to its output side terminals B1 B2, and ceasing the delivery of power and signal to Load 110.

FIG. 2 describes the present invention in its equivalent circuitry format. Said format retains all functionality of the present invention, as described as FIG. 1. Said format also represents the invention as designed and assembled and/or manufactured from off the shelf components as would be utilized in the trade by those familiar in the art.

This embodiment of present invention is of a very simple design and construction while providing a robust alternate to existing signal switching devices.

An advantage of the present invention is its adaptability to utilize various switch activation mechanisms and methods, depending upon performance and circuitry design requirements. Another advantage of the present invention is that its capacitive module and its switching mechanism can be combined and assembled into a monolithic chip, or the switching mechanism of the invention can be a separate external component of the capacitive structure of the invention.

In addition to switching capabilities, the present invention can expand its functionality and utilization by incorporating certain capacitive design specification criteria into its manufacturing. As an alternate embodiment and an example of such expansion of the present invention's functionality is the incorporation of design specifications, as is described in U.S. Pat. No. 9,438,129 Input/Output Power and Signal Transfer Isolator, into the manufacturing of the present invention. With the inclusion of design specifications, as is described in U.S. Pat. No. 9,438,129, into the manufacture of the present invention, the following are some of the features and benefits which would be added to the functionality of the present invention. They would include the providing of an isolation barrier between the capacitive switching device 101 input terminal circuitries from faults and spikes occurring from circuitries connected to its output side terminals, a quick resumption of functionality from faults or spikes occurring, true unidirectional transfer of power or signal, power transfer limiting capabilities, RF filtering capabilities, etc.

Another alternate embodiment of the present invention is where it is utilized as a signal generator and controller. It would be described as a capacitive switching device 101 and method in accordance with present invention, as providing active capacitive switching with utilizing an LC or LR Oscillator as the switch mechanism 112.

With using static or specific inductance oscillator as the switching mechanism 112, and in combination with equivalent capacitance present between A2 and B1, a sinusoidal wave is generated with ability for variable frequency settings, being dependent upon available inductance values and the capacitive values incorporated in the design specifications of present invention. This embodiment structure provides a method for changing switching thresholds at set frequencies and generates specific waves or signals trending between B1 and B2 by combining signal frequency at A1 and A2 with switching frequency at A1 and B1. The signal controlling mechanism is based upon inductance values which, when substituting a static inductance oscillator for a variable inductance oscillator, the inductance values can be changed or controlled.

Many other effective alternatives of the invention will occur to the skilled person in view of the disclosure herein. It will be understood that the invention is not limited to the described embodiments and encompasses such alternatives and modifications to those skilled in the art lying within the spirit and scope of the claims appended hereto.

What is claimed:

1. A capacitive switching device for an alternating current (AC) or pulsed circuit interposed between an AC or pulsed source and a load, comprising:
a set of terminals comprising at least first and second input terminals and at least first and second output terminals that are different than said first and second and input terminals, said first and second and input terminals and said first and second output terminals being configured in the capacitive device such that when said first and second input terminals are connected to the AC or pulsed source and said first and second output terminals are connected to the load, and
at least one power transfer module that transfers power from said first and second input terminals to said first and second output terminals, each of said least one power transfer module comprising:
a first set of two electrode assemblies comprising two decoupled input electrodes, a first one of said input electrodes being coupled to said first input terminal and a second one of said input electrodes being coupled to said second input terminal; and
a second set of electrode assemblies comprising two decoupled output electrodes, a first one of said output electrodes being coupled to said first output terminal and a second one of said output electrodes being coupled to said second output terminal;
said first and second input electrodes both being situated between said first and second output electrodes,
said first and second input electrodes being spaced apart from one another and being spaced apart from an adjacent one of said first and second output electrodes, to enable capacitance to develop between each of said first and second input electrodes and each of second output electrodes when current flows through the AC or pulsed circuit,
said first input terminal is connected to potential current line of said (AC) or pulsed source circuit,
said second input terminal is connected to common current line of said (AC) or pulsed source circuit, and
at least one switching mechanism comprising:
at least one input side and at least one output side and disposed between and connected to second input terminal and first output terminal, and
said switching mechanism providing means of opening or closing said switching mechanism connections between said second input terminals and said first output terminals.

2. The device of claim 1, further comprising at least one layer of dielectric material between each adjacent pair of said input and output electrodes.

3. The device of claim 1, wherein said at least one power transfer module comprises a plurality of power transfer modules arranged in a parallel wiring configuration.

4. The device of claim 1, wherein said first and second input electrodes are decoupled from said first and second output electrodes.

5. The device of claim 1, wherein at least one additional terminal for each input electrode and output electrode is connected to said electrodes.

6. The device of claim 1, wherein the device is a digital switch.

7. the device of claim 1, an electrical system, comprising: the load; the AC source; input circuitry for connecting said first and second input terminals to the AC source; and output circuitry for connecting said first and second output terminals to the load; and switchable circuit connecting common second input terminal coupled to said switching device input terminal; and output terminal of said switching mechanism coupled to said first output potential terminal.

8. A method of controlling the moving or not moving of power forward from an alternating current (AC) or pulsed source to a load through an AC or pulsed circuit using a capacitive arrangement including at least one power transfer and isolator module comprising first and second decoupled output electrodes, first and second decoupled input electrodes arranged between the first and second output electrodes, and dielectric material disposed between each adjacent pair of electrodes, and at least one switching mechanism deposed between and connected to the power source connection to the second decoupled electrode and output connection to the first output electrode, the method comprising:
connecting the first and second input electrodes to the AC source via first and second input terminals, the first input electrode being connected to the AC source via the first input terminal and the second input electrode being connected to the AC source via the second input terminal;
connecting the first and second output electrodes to the load via first and second output terminals that are different than the first and second input terminals, the first output electrode being connected to the load via the first output terminal and the second output electrode being connected to the load via the second output terminal and connecting said switching mechanism to the second input terminal and to first output terminal; and
whereby the moving of power forward is desired, and
whereby said switching mechanism is in open configuration, and
whereby said first input terminal is potential; and
whereby said second input terminal is common; and
whereby said first output terminal is potential; and
whereby said second output terminal is common; and
inducing a potential across first and second output electrodes connected to the load by capacitance between each of first and second input electrodes connected to AC or pulsed source and each of first and second output electrodes connected to the load such that electrical power from AC or pulsed source enters the capacitive arrangement through first and second input terminals and is moved forward to the load through the capacitive arrangement and first and second output terminals; and
whereby properties of the first and second input electrodes, the first and second output electrodes and the dielectric materialize such that an equivalent differential capacitance of input capacitance is greater than a value of output capacitance, and
whereby the ceasing of moving power forward is desired, and
whereby said switching mechanism is in closed configuration, and
whereby said first input terminal is potential; and
whereby said second input terminal is common; and
whereby said first output terminal is neutralized; and
whereby said second output terminal is neutralized; and
whereby removing differential potential across said first and second output electrodes connected to output terminals connected to the load, transfer of power across capacitive switching device ceases.

9. The method of claim 8, wherein first and second input electrodes are electrically AC-AC and signal input electrodes, further comprising decoupling and insulating the electrically AC-AC and signal input electrodes from first and second output electrodes.

10. The method of claim 8, wherein the switching device is an LC or LR oscillator.
